(19) United States
(12) Patent Application Publication
(10) Pub. No.: US 2006/0070665 A1
(43) Pub. Date: Apr. 6, 2006

(54) Volumetric flow regulation valve

(76) Inventors: Manfred Schmitt, Heppenheim (DE); Karsten Mann, Stuttgart (DE); Ulrich Kappenstein, Knittlingen (DE)

Correspondence Address: MICHAEL BEST & FRIEDRICH, LLP, 100 E WISCONSIN AVENUE, MILWAUKEE, WI, 53202, US

(21) Appl. No.: 10/526,268

(22) PCT Filed: May 26, 2003
(86) PCT No.: PCT/DE03/01687

§ 371 Date: Mar. 2, 2005

(30) Foreign Application Priority Data
Sep. 6, 2002 (DE) 102 41 461.0

(51) Int. Cl. F16K 17/30; F16K 21/10

(52) U.S. Cl. 137/514.5; 137/517

(57) ABSTRACT

The invention starts with a volume flow control valve (36, 38) with a flow restrictor (48, 54) that can be displaced axially in a housing (40, 44), via which the volume flow can be diverted. It is proposed that the flow restrictor (48, 54) have a diverting body (54) and the force generated by the diversion at the diverting body (54) be used to adjust the flow restrictor (48, 54).

### PRIOR ART

The invention starts from a volume flow control valve in accordance with the pre-characterizing clause of claim 1.

In addition to an internal combustion engine, additional very different accessory units are attached to the heating/cooling cycle of a motor vehicle, such electrical machines, starters, generators or electronic components for power electronics, gears, hydraulic components, etc. Depending upon the operation state, the units must be heated or cooled, wherein this is accomplished with the aid of a coolant using free or forced convection. In doing so, the coolant flows within the heating-cooling cycle are controlled or regulated to an increasing degree by a central and on-demand type regulation, whose goal is to reduce fuel consumption and pollutants and also increase the motor vehicle comfort.

The individual components of the heating/cooling cycle have different requirements for cooling. In order to meet these requirements, the coolant temperature is adjusted accordingly and the coolant volume flow is regulated or at least restricted in terms of demand via a volume flow control valve.

Volume flow control valves are known from hydraulics and are used there if, for example, the operating speed is supposed to remain constant despite different loads on a consumer. In volume flow control valves of this type, a liquid flows from an inlet, in which a cylindrical flow restrictor with an orifice is arranged, via lateral control openings in the cylinder jacket of the flow restrictor and a ring gap to an outlet. In the process, the control openings restrict the flow-through by cooperating with a control edge in the valve housing. In addition, when the liquid is flowing through, a pressure drop occurs at the orifice, and the flow restrictor is displaced against a spring. With increasing flow speed and consequently an increasing pressure drop, the force acting on the flow restrictor increases so that it is deflected further against the force of a spring and the flow cross-sections of the lateral control openings diminish in accordance with the increased pressure drop. As a result, the flow-through remains approximately constant starting at a nominal pressure difference. There are also volume flow control valves in adjustable designs with adjustable spring prestress and with a check valve.

A volume flow control valve is depicted on Page 821 of the 23^{rd} edition of Bosch's Automotive Handbook. It has an axially displaceable flow restrictor, which includes a control cylinder that is flowed through axially that has radial control openings in the cylinder jacket and a level base part. In addition, a metering orifice and a pressure scale are attached to the flow restrictor. In order to set the volume flow independently of a load pressure on the flow restrictor, the pressure drop at the metering orifice is constantly regulated at the metering orifice via a variable throttle, a pressure scale. In this connection, the pressure drop corresponds to a spring tension acting on the pressure scale.

As a rule, volume flow control valves have a great variety of parts, are very costly to manufacture and are expensive. In addition, they are not suitable for use in all areas of a heating/cooling cycle with thermal management because of the large pressure drop that is required. These cycles are more likely to have low volume flows in some branches, whose flow force on the flow restrictor is therefore not adequate to dimension the spring and the diameter of the flow restrictor in a meaningful way.

### ADVANTAGES OF THE INVENTION

According to the invention, the flow restrictor has diverting body and the force generated by the diversion of the volume flow at the diverting body is used to adjust the flow restrictor. In doing so, the contour of the diverting body (54) is designed expediently so that the largest possible adjusting force is yielded with the lowest possible flow resistance.

If the flow restrictor is comprised of a control cylinder and a base part, the base part can serve as a diverting body in that its contour projects into the control cylinder on its inflow side and is flush at its outflow side and approximately tangentially adjacent at the control openings. Because of this form of base part, a volume flow acting on the flow restrictor is diverted in terms of its direction. Due to the diversion, the volume flow exercises a force on the flow restrictor whose size is a function of the speed of the volume flow. As a result, the flow restrictor is adjusted as a function of the volume flow so that the throttle openings diminish with increasing speed. In contrast to known volume flow control valves, in which the adjusting force is yielded primarily from the static pressure difference at the wetted surfaces of the flow restrictor, with the volume flow control valve in accordance with the invention, the dynamic flow forces are used in the diversion of the flow. In the case of low flow resistance of the volume flow control valve in accordance with the invention, greater forces occur on the flow restrictor as a result of this, so that it is simple to dimension for different application cases, particularly for use in heating/cooling cycle with thermal management. In this case, only small volume flows are present in some branches, whose flow force is not adequate to create a pressure drop required for known volume flow control valves. Therefore, a volume flow control valve in accordance with the invention can advantageously restrict the coolant volume flow through coolant-cooled accessories, such as a starter or a generator, independent of the pump capacity of the coolant pump in the main cycle, to the maximum volume flow required for cooling.

In addition to the contour of the base part, the inner contour of the control cylinder influences the flow speed and the diversion and therefore the adjusting force acting on the flow restrictor. For this reason, the inner contour can run conically towards the contour of the base part. The pressure loss at the flow restrictor, which should be as low as possible, acts against the adjusting force in order to keep the flow resistance within defined limits. As a result, the invention provides for a pressure compensation chamber beneath the flow restrictor and pressure compensation bore holes in the base part, via which a static pressure compensation between the inflow side and the outflow side of the volume flow control valve is achieved.

If, with increasing volume flow through the flow restrictor, the adjusting force exceeds an opposing spring tension, the flow restrictor dips into a stationary guide cylinder, which has a control edge on its end facing the flow restrictor, which now covers the control openings by the amount of the adjusting path. A throttle point is thereby reduced and the desired volume flow is adjusted. Within an operating range, the volume flow increases more or less with further increased pressure in accordance with the spring characteristic and the size of the adjusting path between the completely opened and completed closed valve position. In an ideal case it remains constant after the target volume flow has been reached. In order to come as close as possible to the ideal case, the control openings should already be significantly reduced with a slight increase of the adjusting force acting on the flow restrictor. This is achieved with a long spring that has a flat characteristic curve, with which the spring tension only increases by a very small amount with a small adjusting path. The control openings have a slight extension in the movement direction in order to keep the adjusting path small.

The volume flow characteristic curve of the volume flow control valve in accordance with the invention is adapted qualitatively and quantitatively to the requirements of a specific unit by a corresponding shaping of the base part on the flow restrictor, pressure compensation bore holes with a defined diameter and a special spring characteristic. With corresponding modifications, the volume flow control valve can be used in different branches of the cooling cycle and can therefore be manufactured cost effectively and in large unit numbers. Moreover, it is comprised of fewer components as compared with known valves, because otherwise customary devices to set the spring prestress or check valves are eliminated. The volume flow control valve is constructed to be compact and has a two-piece housing, whereby an upper and a lower housing part each have a hose connection so that the valve can be largely integrated into the area of the hose connection of a to-be-cooled unit in an advantageous manner and no additional construction space is required. In one embodiment of the invention, the volume flow control valve is designed structurally in such a way that it can be integrated into a cooling jacket of a unit. There are additional possibilities for use as a result.

### DRAWINGS

Additional advantages are yielded from the following description of the drawings. Exemplary embodiments of the invention are depicted in the drawings. The drawings, the description and the claims contain numerous features in combination. The person skilled in the art will also observe individual features expediently and combine them into additional, meaningful combinations.

The drawings show:

FIG. 1 A schematic depiction of a heating/cooling cycle of a motor vehicle.

FIG. 2 A longitudinal section through a volume flow control valve in accordance with the invention.

FIG. 3 A variation of FIG. 2.

### DESCRIPTION OF THE EXEMPLARY EMBODIMENTS

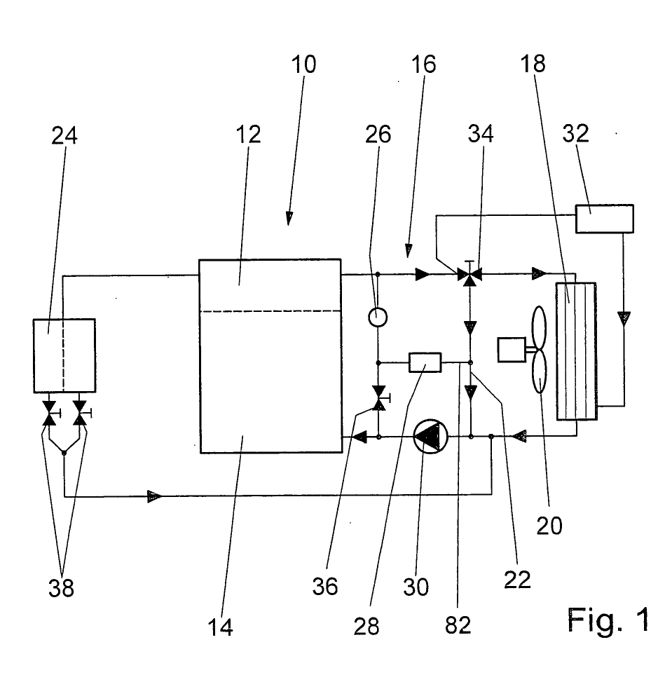

An internal combustion engine 10, with a cylinder head 12 and an engine block 14 is attached to a coolant cycle 16, in which a pump 30 conveys a coolant in the direction of the arrow (FIG. 1). The coolant flows from the cylinder head 12 via a first coolant path 22, a bypass line, directly back to the engine block 14. This small cycle does not produce much cooling capacity so that the internal combustion engine 10 quickly reaches its operating temperature and fuel consumption is advantageously reduced. Provided parallel to the bypass line 22 is a second coolant path to a main cooling element 18, which cooperates with a fan 20 and draws off any excess heat from the coolant. A thermostatic valve 34, which is attached at the branch-off of the second coolant path, distributes the coolant flow to the main cooling element 18 and/or the bypass line 22. The thermostatic valve 34 is designed as a 3-way valve and has an additional connection to the compensating tank 32.

The coolant flows via a third coolant path from the cylinder header 12 to a heater heat exchanger 24 and from there back to the engine block 14 of the internal combustion engine 10. The heater heat exchanger 24 is composed of two components and is used to provide heat for a passenger compartment of the motor vehicle (not shown). Control valves 38, which are expediently triggered in a known manner by an electronic control unit (not shown), restrict the flow through the individual components of the heater heat exchanger 24.

Coolant branches for coolant-cooled electric machines 26, such as starters or generators, and electronic components 28, e.g., power transistors, are provided in the coolant cycle 16. In the example depicted, an electric machine 26 is arranged in a branch line 84 that runs parallel to the bypass line 22. In addition, an electronic component 28 is arranged in a connecting line 82 between the bypass line 22 and the branch line 84. A volume flow control valve 36 is provided in the branch line 84 in order to restrict the coolant flow through the individual units 26, 28 in terms of demand.

In the coolant cycle 16, the control unit determines, as a function of a variety of measured status variables, the coolant capacity demand or heat demand of each individual unit or component covered by the cooling system and regulates the coolant flows individually, however, while taking the overall system into account. In this connection, the pump 30 that can be triggered electrically and the valves 34, 36, 38 make up the adjusting equipment that is required to control the flows of substances and heat. Because of the different demands for cooling capacity or heating capacity, the different coolant branches have to some extent strongly differing coolant volume flows however. Thus, a relatively high coolant volume flow is required for cooling the internal combustion engine 10 in the main coolant cycle of the internal combustion engine 10, which includes the coolant branch via the main cooling element 18 and bypass line 22. In contrast to this, auxiliary units like the electric machines 26 or electronic components 28 require a substantially lower coolant volume flow to adequately cover the cooling demand.

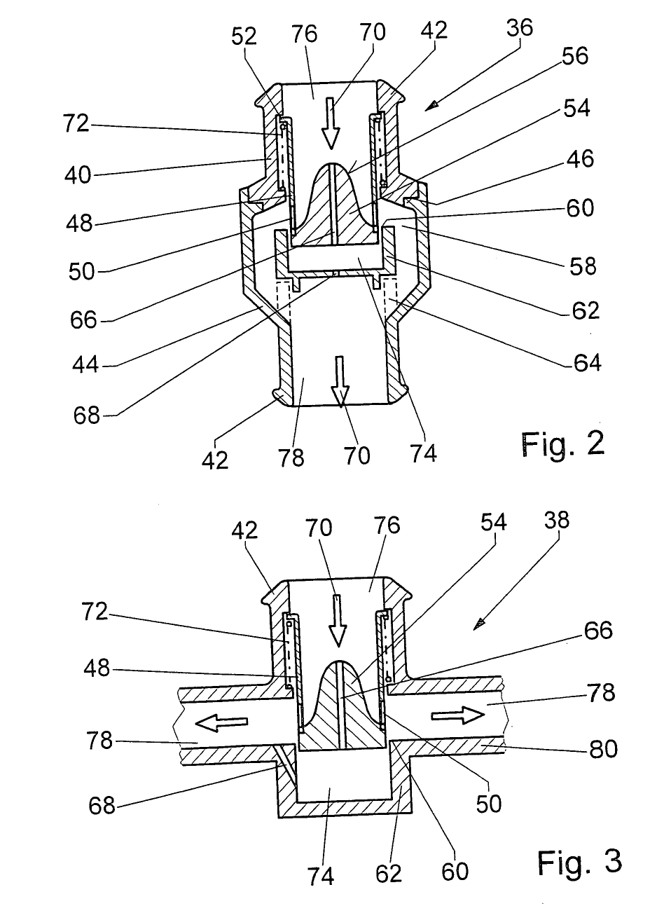

Since the volume flow control valve 36 in accordance with the invention generates the required adjusting force for its flow restrictor 48, 54 less via a pressure drop than via the diversion of the inflowing coolant at a base part 54 serving as a diverting body, it is also suitable for application cases in which the pressure level and the volume flows are relatively low, e.g., in a coolant cycle 16 of an internal combustion engine 10. The volume flow control valve 36, which is arranged in the supply line to the electric machine 26 or the electronic component 28, can be put in a corresponding hose line (FIG. 2) or be an integral part of a cooling jacket 80 of the associated housing.

In the first embodiment (FIG. 2), a housing 40, 44 of the volume flow control valve 36 is divided for simpler manufacturing, whereby the parting line 46 between an upper housing part 40 and a lower housing part 44 runs approximately transverse to the adjusting direction of a flow restrictor 48, 54. The housing parts are tightly connected to each other, e.g., by adhesion or welding or by using a sealing ring by means of screws or the like. They each have a hose connection 42 and are expediently manufactured of plastic in an injection molding method.

The coolant flows from an inlet 76 in the upper housing part 40 in the flow direction 70 to an outlet 78 in the lower housing part 44. In doing so, it first hits the axially displaceable flow restrictor, which has a control cylinder 48 with the base part 54. On the inflow side, the control cylinder 48 has a collar 52 projecting radially outward, which is guided into the inlet 76 of the upper housing part 40 and on which an end of a spring 72 supports itself. The other end of the spring 72 is held in the upper housing part 40.

The base part 54 has a contour 56 projecting into the control cylinder 48, via which the coolant volume flow is diverted to control openings 50 arranged radially in the control cylinder 48. The contour 56 of the base part 54 is flush at its outflow side and approximately tangentially adjacent at the control openings 50 so that with completely opened control openings 50, the coolant flow is diverted with practically no loss. Due to the shape of the contour 56 and, if applicable, the shape of the inner wall of the control cylinder 48, the flow cross-section diminishes so that the speed increases with the same volume flow and a substantial adjusting force is generated with the diversion of the volume flow, which is approximately proportional to the square of the flow speed. With a constant volume flow, an equilibrium sets in between the adjusting force and the force of the spring 72. If the adjusting force increases with increasing volume flow, the flow restrictor 48, 54 is shifted against the force of the spring 72 into a housing-mounted guide cylinder 62, whereby the control openings 50 augmented by a control edge 60 on the upper edge of the guide cylinder 62 are covered over and reduced. The volume flow is reduced as a result so that is it kept approximately constant to the desired degree. To achieve this, the opening cross-section of the control openings 50 must change significantly when the adjusting force changes. This is achieved in an advantageous manner with a long spring 72, whose spring tension increases only insignificantly with a small adjusting path. Therefore, in order to keep the adjusting path small, the control openings are dimensioned to be small in the adjusting direction. In the case of a reducing volume flow, the spring 72 again adjusts the control cylinder 48 in the opening direction so that the flow cross-section of the control openings 50 increases again.

In the design of the volume flow control valve 36 according to FIG. 2, the guide cylinder 62 is held in the lower housing part 44 by connecting pieces 64 and is surrounded by a ring gap 58. After passing through the control openings 50, the coolant flows through this [gap] to the outlet 78, which is arranged coaxially to the inlet 76. In the design shown in FIG. 3, the outlet 78 is transverse to the inlet 76 so that the ring gap 58 can be eliminated. A hose connection 42 is provided at the inlet 76.

The guide cylinder 62 forms a pressure compensation chamber 74 with the base part 54, and this chamber is connected to the inlet 76 on the one hand via a pressure compensation bore hole 66 and to the outlet 78 on the other hand via a pressure compensation bore hole 68. The pressure compensation bore holes 66 influence the pressure difference between the inlet 76 and the outlet 78, thereby providing an additional parameter for setting the volume flow.

Therefore, important degrees of freedom in dimensioning the volume flow control valve 36 are the shape of the base part 54 and the control openings 50, which have a slight extension in the movement direction of the flow restrictor, as well as the spring tension, which is determined by a flat characteristic curve, and the flow resistance of the volume flow control valve 36, which is influenced by the pressure compensation bore holes.

1. Volume flow control valve (36, 38) with a flow restrictor (48, 54) that can be displaced axially in a housing (40, 44), via which the volume flow can be diverted, characterized in that the flow restrictor (48, 54) has a diverting body (54) and the force generated by the diversion at the diverting body (54) is used to adjust the flow restrictor (48, 54).

2. Volume flow control valve (36, 38) according to claim 1, characterized in that the contour (56) of the diverting body (54) is designed so that the largest possible adjusting force is yielded with the lowest possible flow resistance.

3. Volume flow control valve (36, 38) according to claim 1 with a flow restrictor (48, 54) that has a control cylinder (48) that is flowed through axially with a base part (54) serving as a diverting body, in whose area radially directed control openings (50) are provided in the control cylinder (48), which cooperate with a control edge (60) in the housing (40, 44), whereby a spring (72) loads the flow restrictor (48, 54) against the flow direction (70) of the volume flow, characterized in that the base part (54) has a contour (56) projecting into the control cylinder (48), via which the volume flow is diverted to the control openings (50).

4. Volume flow control valve (36, 38) according to claim 3, characterized in that the contour (56) is flush at its outflow side and approximately tangentially adjacent at the control openings (50).

5. Volume flow control valve (36, 38) according to claim 1, characterized in that the flow restrictor (48, 54) during its movement dips into a housing-mounted guide cylinder (62), which has a control edge (60) on its end facing the flow restrictor (48, 54), which in its functional position more or less covers the control openings (50).

6. Volume flow control valve (36, 38) according to claim 3, characterized in that the guide cylinder (62) has a pressure compensation chamber (74), which is connected via a pressure compensation bore hole (66, 68) to an inflow side and/or outflow side of the volume flow control valve (36, 38).

7. Volume flow control valve (36, 38) according to claim 1, characterized in that the inner contour of the control cylinder (48) runs conically towards the contour (56) of the base part (54).

8. Volume flow control valve (36, 38) according to claim 1, characterized in that on the inflow side the control cylinder (48) has a collar (52) projecting radially outwardly on which a spring (72) is supported.

9. Volume flow control valve (36, 38) according to claim 1, characterized in that the spring (72) has a flat characteristic curve and the control openings (50) have a slight extension in the movement direction of the flow restrictor (48, 54).

10. Volume flow control valve (36, 38) according to claim 1, characterized in that the housing (40, 44) is designed to be two-piece, wherein a parting line (46) runs essentially transverse to the movement direction of the flow restrictor (48, 54) and is sealed towards the outside.

11. Volume flow control valve (36, 38) according to claim 10, characterized in that the upper housing part (40) and the lower housing part (44) each have a hose connection (42).

12. Volume flow control valve (36, 38) according to claim 1, characterized in that it is integrated into the cooling jacket (80) of a machine (26) or a component (28).

13. Volume flow control valve (36, 38) according to claim 1, characterized in that, in a heating/cooling cycle of a motor vehicle, it regulates the volume flow of a branch line (84) of the heating/cooling cycle.

14. Volume flow control valve (36, 38) according to claim 2 with a flow restrictor (48, 54) that has a control cylinder (48) that is flowed through axially with a base part (54) serving as a diverting body, in whose area radially directed control openings (50) are provided in the control cylinder (48), which cooperate with a control edge (60) in the housing (40, 44), whereby a spring (72) loads the flow restrictor (48, 54) against the flow direction (70) of the volume flow, characterized in that the base part (54) has a contour (56) projecting into the control cylinder (48), via which the volume flow is diverted to the control openings (50).

15. Volume flow control valve (36, 38) according to claim 2, characterized in that the flow restrictor (48, 54) during its movement dips into a housing-mounted guide cylinder (62), which has a control edge (60) on its end facing the flow restrictor (48, 54), which in its functional position more or less covers the control openings (50).

16. Volume flow control valve (36, 38) according to claim 3, characterized in that the flow restrictor (48, 54) during its movement dips into a housing-mounted guide cylinder (62), which has a control edge (60) on its end facing the flow restrictor (48, 54), which in its functional position more or less covers the control openings (50).

17. Volume flow control valve (36, 38) according to claim 4, characterized in that the flow restrictor (48, 54) during its movement dips into a housing-mounted guide cylinder (62), which has a control edge (60) on its end facing the flow restrictor (48, 54), which in its functional position more or less covers the control openings (50).
